(19) United States
(12) Patent Application Publication
(10) Pub. No.: US 2014/0344834 A1
(43) Pub. Date: Nov. 20, 2014

(54) PROVIDING AUDIBLE NOTIFICATIONS FOR WEBMAIL APPLICATIONS

(71) Applicants: Balázs Tibor Szabó, Oberrieden (CH); Carl A. Haverl, Aptos, CA (US); Michael P. Davidson, Seattle, WA (US)

(72) Inventors: Balázs Tibor Szabó, Oberrieden (CH); Carl A. Haverl, Aptos, CA (US); Michael P. Davidson, Seattle, WA (US)

(73) Assignee: Google Inc., Mountain View, CA (US)

(21) Appl. No.: 13/424,295

(22) Filed: Mar. 19, 2012

(51) Int. Cl. G06F 9/54

(52) U.S. Cl. 719/318

(57) ABSTRACT

A system and machine-implemented method for providing an audible notification to a user while an active window of an application is running in the foreground on the user's device. A first content update is detected in the active window, and a signal to produce an audible notification in response to the detection of the first content update is provided to the user's device. After a subsequent content update is detected in the active window, an elapsed time from the audible notification in response to the detection of the first content update is determined. A signal to produce an audible notification in response to the detection of the subsequent content update is provided to the user's device when the elapsed time is longer than a predetermined interval.

### FIELD

The present disclosure generally relates to providing audible notifications to users of changes in content displayed in a user interface.

### BACKGROUND

Web-based applications generally provide visual prompts in a user interface to notify users of changes to the content displayed. For example, when a user receives new incoming emails, certain text corresponding to the new email may appear in an inbox to indicate this change. Furthermore, a display of a number indicating the amount of unread emails in the inbox may be changed to reflect this change. However, these types of indications may not be appreciated by individuals who are vision impaired. Thus, it may be desirable to implement a system that provides audible notification of changes in the user interface.

### SUMMARY

The disclosed subject matter relates to a machine-implemented method for providing an audible notification indicating to a user while an active window of an application is running in the foreground on the user's device. A first content update is detected in the active window, and a signal to produce an audible notification in response to the detection of the first content update is provided to the user's device. After a subsequent content update is detected in the active window, an elapsed time from the audible notification in response to the detection of the first content update is determined. A signal to produce an audible notification in response to the detection of the subsequent content update is provided to the user's device when the elapsed time is longer than a predetermined interval.

According to various aspects of the subject technology, a system comprising one or more processors and a machine-readable medium comprising instructions stored therein, which when executed by the processors, cause the processors to perform operations comprising providing an audible notification to a user's device indicating updates in content. A first update of content of an application running in an active window on a user's device is detected. A signal to produce an audible notification in response to the detection of the first update of content is provided to the user's device. At least one subsequent update of content of the application is detected, and events corresponding to the detected at least one subsequent update since the detection of the first update are aggregated. An elapsed time from a time of the detection of the first update is determined. A signal to produce an audible notification in response to the detection of the at least one subsequent update is provided to the user's device when the elapsed time is longer than a predetermined interval.

The disclosed subject matter also relates to a machine-readable medium comprising instructions stored therein, which when executed by a system, cause the system to perform operations comprising providing an audible notification to a user operating a web-mail application. A first update of a number of unread emails in an inbox of a web-based email application running on the user's device is detected at an initiation of the web-based email application. A signal to produce a first audible notification in response to the detection of the first update of the number of unread emails is provided to the user's device. After a subsequent update of the number of unread emails in the inbox of the web-based email application is detected, an elapsed time from the detection of the first update is determined. A signal to produce an audible notification in response to the detection of the subsequent update is provided to the user's device when the elapsed time is longer than a predetermined interval.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment which provides for web-based applications that provide audible notifications indicating changes in status of user interfaces.

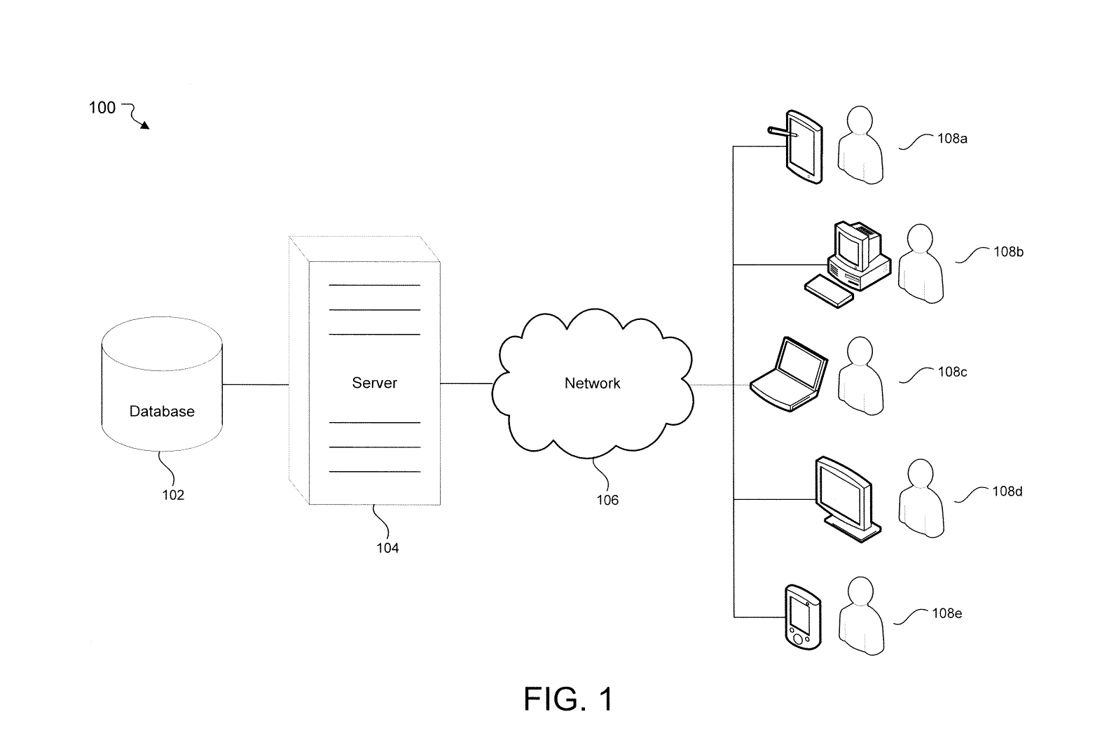

FIG. 2 illustrates an example of a client device system for providing audible notification indicating a change in a status of a user interface.

FIG. 3 illustrates an example method for providing signals to produce audible notifications indicating changes in content of an active window.

FIG. 4 provides a graphical representation of an example webmail user interface that provides audible notification to indicate a change in status.

FIG. 5 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter describes systems and techniques for providing an audible notification indicating to a user while an active window of an application is running in the foreground on the user's device. A first content update is detected in the active window, and a signal to produce an audible notification in response to the detection of the first content update is provided to the user's device. After a subsequent content update is detected in the active window, an elapsed time from the audible notification in response to the detection of the first content update is determined. A signal to produce an audible notification in response to the detection of the subsequent content update is provided to the user's device when the elapsed time is longer than a predetermined interval.

When an application is launched in an active window, a first content update is detected in the active window, and a signal to produce an audible notification in response to the detection of the first content update is provided to the user's device. When the active window is refreshed and new information appears, a subsequent update in content may be detected. In some implementations, live regions indicating a section of a screen that contains dynamic information (e.g., number of emails in an inbox, a stock ticker, sports scores, etc.) may be designated for identification. If a predetermined time interval from the provision of the signal corresponding to the detection of the first content update has elapsed, a signal to produce an audible notification in response to the detection of the subsequent content update is provided to the user's device. The audible notification may simply indicate that a content change has occurred (e.g., you received new emails), or it may provide more detailed information about the change (e.g., you received a new email from John Doe with a subject line “hello” two minutes ago).

Network environment 100 comprises one or more databases 102 (e.g., computer-readable storage devices) for storing a variety of data accessed by web-based applications. The network environment 100 further comprises one or more servers 104. Server 104 may receive requests from user-operated client devices 108a-108e. Server 104 and client devices 108a-108e may be communicatively coupled through a network 106. In some implementations, client devices 108a-108e may request data from server 104. Upon receiving the request, server 104 may retrieve a set of data from database 102 and serve the set of information to client devices 108a-108e.

Each of client devices 108a-108e can represent various forms of processing devices. Example processing devices can include a desktop computer, a laptop computer, a handheld computer, a television with one or more processors attached or coupled thereto, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices.

In some aspects, client devices 108a-108e may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver. Client devices 108a-108e may also operate in an offline mode, where operations may be performed on client devices 108a-108e when the client devices are not connected to or in communication with the server.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108a-108e) can communicate with servers 104 via a virtual private network (VPN), Secure Shell (SSH) tunnel, hypertext transfer protocol (http), hypertext transfer protocol secure (https), or other secure network connection. In some aspects, network 106 may further include a corporate network (e.g., intranet) and one or more wireless access points.

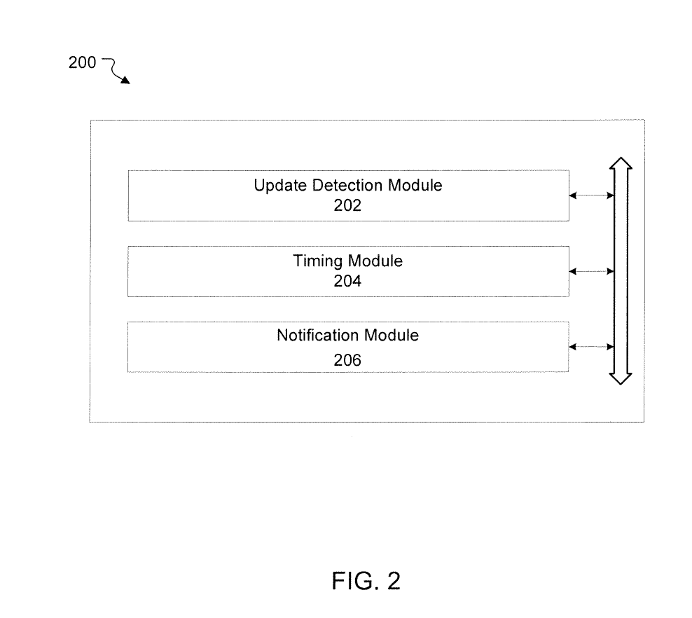

FIG. 2 illustrates an example of a system utilized for providing an audible notification indicating a change in the status of a user interface. System 200 includes update detection module 202, timing module 204, and notification module 206. These modules, which are in communication with one another, process information retrieved from database 102 in order to determine when an audible notification is to be provided. For example, when a screen is refreshed and new information appears on the screen, an update in content may be detected by update detection module 202. An audible notification may be provided by notification module 206 when update detection module 202 detects a first content update in an active window. An audible notification may also be provided by notification module 206 when update detection module 202 detects a subsequent content update in the active window and timing module 204 determines an elapsed time from the first detection to the subsequent detection is longer than a predetermined interval. The notification provided may indicate the detected update of the content.

In some aspects, the modules may be implemented in software (e.g., subroutines and code). The software implementation of the modules may operate on web browsers that utilize screen readers (e.g., using ARIA markup) running on client devices 108. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

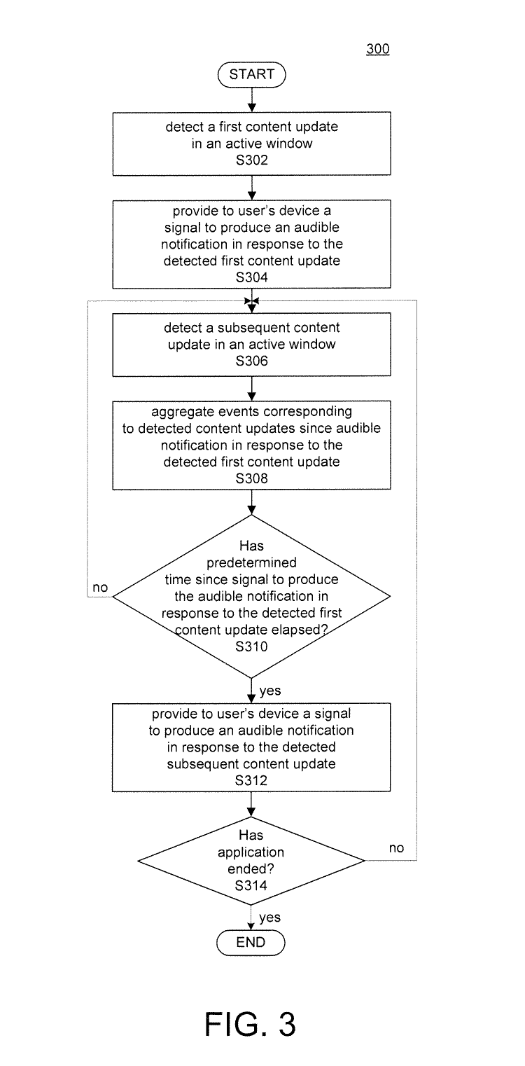

FIG. 3 illustrates example method 300 for providing an audible notification to a user while an active window of an application is running in the foreground on the user's device. A first content update in the active window is detected in S302. A signal to produce an audible notification may be provided to the user's device in response to the detection of the first content update in S304. Audible notifications are utilized to indicate changes in the content in an active window of an application such as webmail applications. For example, when additional emails are received by the webmail application, the content indicating the number of unread emails may change. When a change in the content is detected, a signal to produce an audible notification may be provided to the user's device to indicate the detected update of the content.

In some implementations, live regions may be designated to indicate a section of a screen that contains dynamic information. For example, a section of a webmail application indicating a number of unread emails in an inbox may be designated as a live region. When additional emails are received, a resulting change in the number of unread emails in the designated live region may be detected, and a signal to produce an audible notification indicating a change in the number of unread emails may be provided to the user's device. Live regions, which are used by screen readers to detect changes on a display, may operate in the background so as to not distract users who do not require the use of screen readers. The screen readers identify changes in the live region; however, notifications of the changes are provided at periodic intervals since providing a notification for every change in the live region may be distracting to a user. Live regions may be designated in several other types of web-based applications that include periodically updated information (e.g., stock ticker, sports scoreboards, etc.) for performing the same functions.

A subsequent content update may be detected in the active window in S306. Each subsequently detected content update since the audible notification in response to the detected first content update may be aggregated as events in S308. When the predetermined time since the signal to produce the audible notification in response to the detected first content update has not elapsed in S310, method 300 returns to S306 to detect subsequent content updates in the active window. When a predetermined time since the signal to produce the audible notification in response to the detected first content update has elapsed in S310, a signal to produce an audible notification in response to the detected subsequent content update is provided to the user's device in S312. That is, events related to each detected content update since the signal corresponding to the detected first content update was provided to the user's device are aggregated so that information relating to the aggregated events may be provided in a signal to produce an audible notification in response to the detected subsequent content update. In S314, a determination is made whether or not the application has ended. If the application has ended (i.e., the application has been shut down by the user), then no additional audible notifications corresponding to the application are processed. If the application has not ended, method 300 again returns to S306 to detect subsequent content updates in the active window.

Referring back to the webmail example discussed above, the events aggregated in S308 may correspond to receipt of new emails, and the detected updates of content may correspond to the detected changes in an indicator of the number of unread emails in an inbox. The aggregation of events may also include an aggregation of information corresponding to the newly received emails such as sender, subject, time received, etc.

In some implementations, the predetermined time period may be utilized to provide regular intervals at which notifications are provided. For example, setting the predetermined time period to five minutes would cause five minute intervals to elapse between provisions of signals to produce audible notifications of updates of content (when updates are detected), so as to not interrupt the user with a notification each time an update of content is detected. When the predetermined time period has not elapsed, method 300 returns to S306 to continue detecting and aggregating as events the subsequently detected content updates.

In some implementations, a determination of whether the user is currently engaged in using an application is made. When the user is determined to be engaged in using an application, the providing the signal to produce the audible notification in response to the detection of the subsequent content update is delayed. When the user is determined to not be engaged in using an application, the signal to produce the audible notification in response to the detection of the subsequent content update is provided to user's device. For example, if the user is composing an email in a webmail application, or if the user is drafting a document in a word processing application, the user may be determined to be engaged in using an application. By delaying the signal to produce the audible notification this instance, the user is not interrupted by the audible notification until the user has stopped using the application.

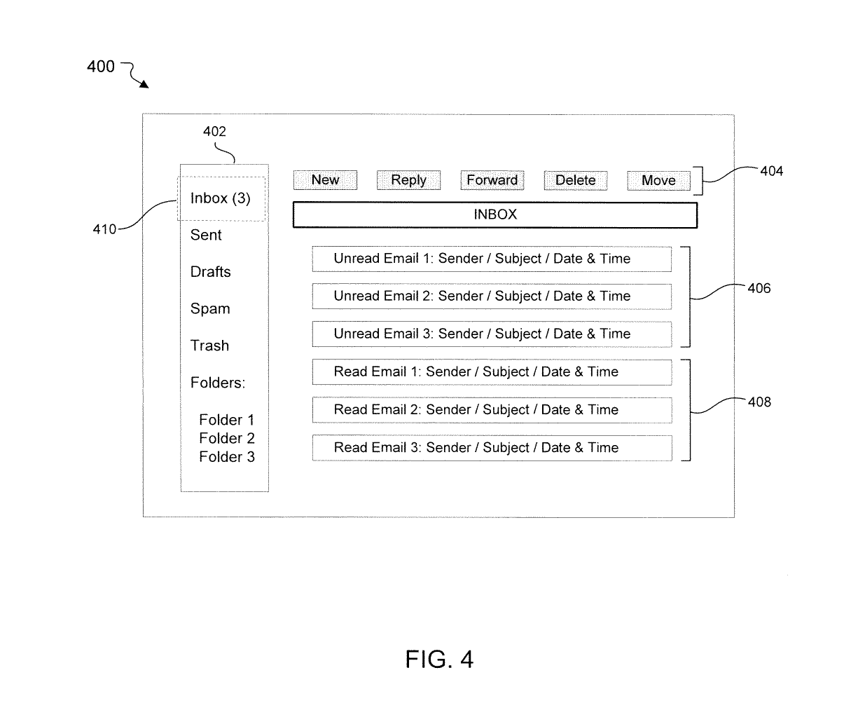

FIG. 4 provides a graphical representation of an example user interface of a webmail application for which audible notifications may be provided. The audible notifications are utilized to indicate changes in the status of the user interface of the webmail application. Webmail application 400 may include folder selection box 402. In some implementations, folder selection box 402 may include an inbox, a sent box, a drafts box, a spam box, a trash box, and one or more user defined folders. Webmail application 400 further includes action selection box 404. Action selection box 404 may provide several action buttons from which the user may choose. The action buttons may include a “new” button for creating a new email, a “reply” button for replying to an email, a “forward” button for forwarding an email, a “delete” button deleting an email, and a “more” button that displays a variety of additional actions in a drop-down menu. Webmail application 400 may further include a display area for listing several unread emails 406 and several read emails 408 in the selected item from the folder selection box 402. For each email, information including an email address of a sender, a subject, and a time stamp may be displayed.

The user interface of the webmail application may also include live region box 410 that encompasses an area of folder selection box 402 corresponding to the inbox. Live region box 410 indicates a section of a screen that contains dynamic information designated for identification. The inbox label may include a number indicating the number of unread emails (e.g., three unread emails in this example). When additional emails are received by the webmail application, the number indicating the number of unread emails may change. Changes in live region box 410 may be identified. When a change in the number is identified, an audible notification may be provided to the user to indicate the detected update of the content.

In some implementations, the audible notification is provided only when a predetermined time interval from a previous audible notification has elapsed. That is, the audible notification may not be provided after every identified change in live region box 410. Instead, the audible notifications are provided when it is determined that an interval of time since the previous audible notification has passed. In some implementations, the audible notification may simply indicate that a change has occurred (e.g., a new email had been received). For example, a change in a live region encompassing “Inbox (x)” may result in a audible notification of “inbox x” to be outputted to the user. If the user, however, prefers a customized audible notification, an invisible live region may be created from which the screen reader reads. For example, an invisible live region with the text “You have x new mail” may be created so that the audible notification may provide a corresponding audible notification. The live region may also be modified to include more detailed information such as an email address of the sender or a subject line corresponding to the particular email (e.g., you received a new email from John Doe with a subject line “hello” two minutes ago).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic or other storages, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

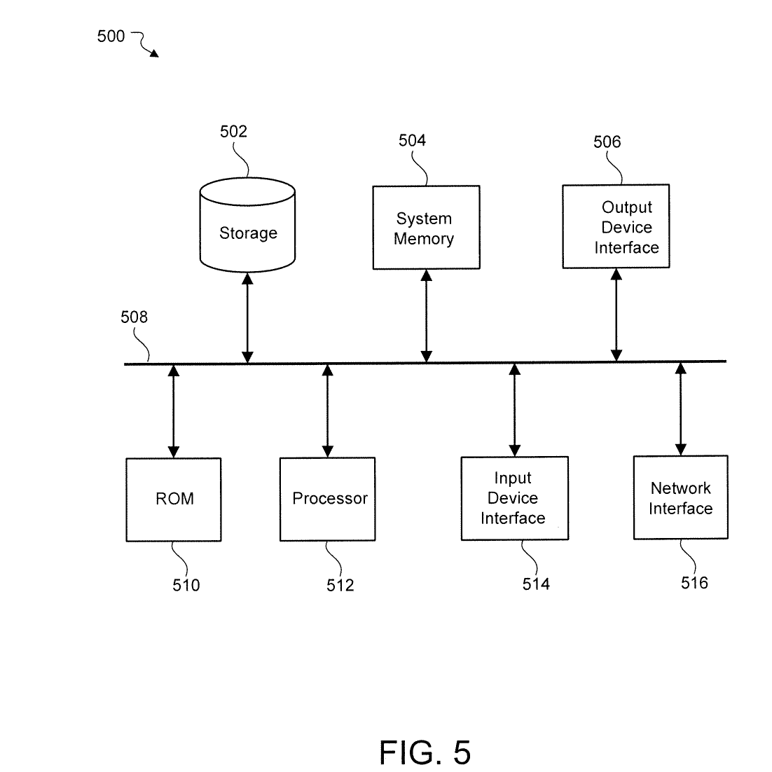

FIG. 5 conceptually illustrates an example electronic system with which some implementations of the subject technology are implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for providing audible notifications to user devices of changes in content displayed in an active window in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers, such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for providing an audible notification to a user while an active window of a first application is running in the foreground on a user's device, the method comprising:
detecting a first content update in the active window of the first application;
providing to the user's device a first signal to produce a first audible notification in response to the detection of the first content update;
detecting a plurality of subsequent content updates in the active window within a predetermined period of time after providing the first signal to produce the first audible notification;
aggregating the subsequent content updates for representation in a second audible notification; and
providing to the user's device a second signal to produce the second audible notification after the predetermined of time expires, the second audible notification describing the aggregated subsequent content updates

2. The method of claim 1, further comprising determining whether a second application is being utilized on the user's device, wherein providing the second signal is delayed while the second application is determined as being utilized on the user's device.

3. The method of claim 2, wherein when the active window of the first application returns to the foreground after being an inactive window in the background.

4. The method of claim 1, further comprising:
determining an elapsed time from a time when the active window of the first application returns to the foreground after being an inactive window in the background; and
providing to the user's device a second signal when the active window of the first application returns to the foreground after the predetermined of time expires.

5. The method of claim 1, wherein detecting the first and plurality of subsequent content updates in the active window is performed by a screen reader, and wherein the screen reader utilizes Accessible Rich Internet Application (ARIA) extension.

6. The method of claim 1, wherein the first and second signals comprises comprise information corresponding to at least one of an email inbox, a stock ticker, or a sports scoreboard.

7. The method of claim 6, wherein the detected first and plurality of subsequent content updates are associated with received new emails, and wherein the information comprises at least one of an email address of a sender of the received new email, a subject line of the received new email, and a time stamp corresponding to a time of receipt of the received new email.

8. The method of claim 1, further comprising providing a shortcut corresponding to each of the detected first and plurality of subsequent content updates, wherein activation of the shortcut opens a file corresponding to a detected content update.

9. The method of claim 8, wherein each shortcut is associated with a received new email, and wherein the activation of the shortcut opens an email file corresponding to the received new email.

10. The method of claim 1, wherein detecting the content first and plurality of subsequent updates comprises detecting an update of one or more live regions, each of the one or more live regions corresponding to a section of a screen containing dynamic information.

11. A machine-readable medium comprising instructions stored therein, which when executed by a system, cause the system to perform operations comprising:
detecting a first update of a number of unread emails in an inbox of a web-based email application running on in an active window of a user's device at an initiation of the web-based email application;
providing to the user's device a first signal to produce a first audible notification in response to the detection of the first update of the number of unread emails;
detecting a plurality of subsequent updates to the number of unread emails in the inbox of the web-based email application within a predetermined interval of time from the detection of the first update; and
providing to the user's device a second signal to produce a second audible notification in response to the detection of the subsequent updates after the predetermined interval of time, the second audible notification describing an aggregation of the plurality of subsequent updates.

12. The machine-readable medium of claim 11, wherein the second audible notification provides information including at least one of a number of new unread emails since a previous audible notification, email addresses of senders of each of the new unread emails, a subject line of each of the new unread emails, or a time stamp corresponding to a time of receipt of each of the new unread emails.

13. The machine-readable medium of claim 11, wherein the second audible notification provides information including the number of new unread emails since the previous audible notification, and wherein the number of new unread emails is a difference between a number of unread emails at a time of the detection of the first update and a number of unread emails at a time of the detection of the plurality of subsequent updates.

14. The machine-readable medium of claim 11, wherein the web-based email application is a first application, the operations further comprising determining whether a second application is being utilized by a user, wherein providing to the user's device the signal to produce the second audible notification is delayed while the second application is determined as being utilized by the user.

15. The machine-readable medium of claim 11, the operations further comprising providing shortcuts corresponding to the detected first update and the detected plurality of subsequent updates, wherein activation of each of the shortcuts opens an email file corresponding to a detected update.

16. The machine-readable medium of claim 11, wherein detecting the first update and plurality of subsequent updates is performed by a screen reader, and wherein the screen reader utilizes Accessible Rich Internet Application (ARIA) extension.

17. The machine-readable medium of claim 11, wherein detecting the first update and subsequent updates comprises detecting an update of a live region, the live region corresponding to a section of a screen containing dynamic information relating to the number of emails in an inbox.

18. A system for providing for providing an audible notification to a user operating a computing device, the system comprising:
one or more processors; and
a machine-readable medium comprising instructions stored therein, which when executed by the processors, cause the processors to perform operations comprising:
detecting, by the one or more processors, a first update of content of a first application running in an active window on a user's device;
providing to the user's device a first signal to produce a first audible notification in response to the detection of the first update of content;
detecting, by the one or more processors, a plurality of subsequent updates of content of the first application;
aggregating events corresponding to the detected plurality of subsequent updates over a period of time since the detection of the first update;
and
providing to the user's device a second signal to produce a second audible notification in response to the detection of the at least one subsequent update when the elapsed time is longer than a predetermined interval, the second audible notification describing the aggregated events.

19. The system of claim 18, wherein each of the aggregated events corresponds to a newly received email, and wherein the the second audible notification provides information for each of the newly received email, the information including at least one of an email address of a sender of an email, a subject line of the email, or a time stamp corresponding to a time of receipt of the email.

20. The system of claim 18, wherein the operations further comprise determining whether a second application is an active window on the user's device, wherein providing the second audible notification to the user is delayed when the second application is determined as being an active window on the user's device.
